(19) United States
(12) Patent Application Publication
(10) Pub. No.: US 2021/0241384 A1
(43) Pub. Date: Aug. 5, 2021

(54) METHOD FOR DETERMINISTIC RECONCILIATION AND MATCHING OF PAYMENTS WITH ACCOUNTS RECEIVABLE

(71) Applicant: salesforce.com, inc., San Francisco, CA (US)

(72) Inventors: Pedro Dal Col, Sacramento, CA (US); Carlos Ramirez Martinez-Eiroa, Naperville, IL (US); Wei Zhang, Vancouver (CA)

(21) Appl. No.: 16/779,360

(22) Filed: Jan. 31, 2020

(51) Int. Cl. G06Q 40/00; G06Q 40/02; G06Q 30/02

(52) U.S. Cl. CPC G06Q 40/125; G06Q 30/0279; G06Q 40/02

(57) ABSTRACT

A computer implemented method to implement deterministic reconciliation and matching of payments with accounts receivable revenue for a donation management system. The method includes receiving actual payment information from a fundraising system, determining a set of donations, installments, and fund allocations affected by the actual payment information, matching the actual payment information against the set of donations, installments, and fund allocations, and adjusting recorded revenue amounts for at least one fund allocation record and payment record, in response to mismatching of the actual payment information against the set of opportunities, installments, and fund allocations in at least one database of an accounting management system.

### TECHNICAL FIELD

One or more implementations relate to the field of donation management systems; and more specifically, to method and system to manage reconciliation and matching of actual payments with revenue.

### BACKGROUND ART

Nonprofit organizations and similar entities are often reliant on donations to financially support their operations. These donations are often promised to the nonprofit organization before the money is given to the nonprofit. In some cases, the promised money is paid in installments over time. These installments are scheduled and tracked by the nonprofit. The donors however do not always adhere to the schedule or make payment amounts according to the schedule. This creates ongoing work for the nonprofit to apply payments to the correct funds, and to track and adjust the payment schedule.

In many cases, nonprofits utilize accrual accounting to track donations. Under accrual accounting, the nonprofits are required to treat promised donations as “revenue” at the time the amounts of the donations are promised. That revenue, even if no money has actually been received, needs to be entered in the accounting system and reported to the appropriate revenue agency (e.g., the internal revenue system (IRS) in the United States). Since this means that revenue might be recognized, recorded, and reported to the appropriate agency before it is received, once the actual payments come in, that money must be matched to the recorded and reported revenue. This is a straightforward task if donors pay the amount of money that they promised, according to the schedule they agreed to, and designate it as promised (i.e., the money is typically promised to specific target funds, which can be later changed). If that is not the case, because the donor modifies the agreed payment schedule, amount, or target fund any time after their initial commitment, then the accounting and tracking process is complicated for the nonprofit to manage.

There are three components to revenue: amount, due date, and fund allocation. All three components need to line up when matching payments to revenue. A mismatch in any of these three areas must be reconciled. In order for a donation tracking and management system to support accrual accounting, it needs to track revenue and the actual payments separately.

Donation management systems including accounting management systems can be services offered in a multi-tenant cloud computing platform. A multi-tenant cloud computing platform supports one or multiple services that are made available to tenants of the multi-tenant cloud computing platform. The services are sets of functions, applications, and/or resources that may be made available on-demand to the tenants of the multi-tenant cloud computing platform. The tenants of the multi-tenant cloud computing platform can leverage these services to support their organization. Thus, an organization of a tenant does not need to be concerned with building and/or maintaining the provided services, but instead makes use of the services when needed (e.g., in response to a demand from a tenant). The services may communicate with each other and/or with one or more electronic devices external to the multi-tenant cloud computing platform via one or more Application Programming Interfaces (APIs) (e.g., a Representational State Transfer (REST) API).

The multi-tenant cloud computing platform can also provide a set of resources to tenants. For example, the resources may include a set of databases and the services use data stored within the set of databases. The set of databases may each comprise one or more database objects that are managed by a Database Management System (DBMS). Each database object may include a number of records and each record may comprise a set of fields.

### BRIEF DESCRIPTION OF THE DRAWINGS

The following figures use like reference numbers to refer to like elements. Although the following figures depict various exemplary implementations, alternative implementations are within the spirit and scope of the appended claims. In the drawings:

FIG. 1 is a block diagram of a donation management system that includes an accounting management system that implements a deterministic reconciliation and matching of payments with accounts receivable.

FIG. 2 is a flowchart of one embodiment illustrating a deterministic reconciliation and matching of payments with accounts receivable.

FIGS. 3A-D are flowcharts of one embodiment illustrating an example implementation of deterministic reconciliation and matching of payments with accounts receivable.

FIGS. 4A-4C are a flowchart of one example implementation of a process for refund processing.

FIGS. 5A and 5B are diagrams of a multi-tenant distributed cloud computing platform supporting the donation management system including the accounting management system.

### DETAILED DESCRIPTION

The following description describes methods and apparatus for a method and system of automated revenue matching that allow a user to directly modify the payment and its schedule. The method and system will automatically update the revenue as needed to satisfy accrual accounting requirements. The method and system provide deterministic reconciliation and matching of payments with accounts receivable.

Overview

A common task for accounting departments is to match revenue (pledges or invoices) and cash when a payment is received. This usually involves manual investigation or guessing when more than one invoice or pledge is outstanding. The non-deterministic nature of this process often leads to inconsistencies and is prone to human error resulting in time consuming ledger corrections and adjustments.

In the non-profit area, there are added complexities because pledged amounts (revenue/invoices) can be allocated to one or more funds. When actual payments are received, revenue must be satisfied based on the allocation to specific funds that the donor indicates for that payment. Each allocation designated by or associated with the payment needs to be matched with revenue that was originally allocated to that fund. In some cases, it might also be necessary to reclassify the pledged amount in order to reconcile it with the actual payment/s received.

The embodiments provide a method to ensure that this issue is resolved in an automated, consistent, and deterministic way. The embodiments operate by splitting payments first into installments, then splitting them into allocations, matching those allocations to recognized revenue, and then, reconciling pledged allocations if necessary. The process can be referred to as SISAMAR (Split into Installments, Split into Allocations, Match to recognized revenue, and Reconcile).

The embodiments overcome the issues of the prior art systems. There are many issues with systems that support accrual accounting. One of the issues is that these systems might provide the incorrect information about remaining revenue after some payments have been received due to improper resolution of mismatches between the received payments and recognized revenue. These mismatches can cause issues if unrealized revenue is used in financial planning or forecasting. Another issue is that, without an automated method and system for resolving issues with actual payments and recognized revenue, users need to manually maintain records to ensure they match with the most up to date payment information. This manual process can be inefficient and error prone due to human mistakes or missing information. Also, there might be security concerns with allowing human interaction with the financial data directly and the separate tracking of this information.

The embodiments overcome these issues by providing a system with automation to ensure the accuracy of unrealized revenue by assuming prepayment of future installments first before performing any reclassifications. Thus, the embodiments indirectly ensure accuracy of unrealized revenue by properly matching realized revenue, and by avoiding unnecessary realized revenue reclassification.

The embodiments support accounting and donation management systems that work with accrual accounting. In some embodiments, the accounting and donation management systems implement the implied revenue recognition method to maintain the remaining implied revenue when the actual payment comes in. In order to maintain the remaining implied revenue, the reconciliation process will create new ledger entries, e.g., Payment Transaction Ledger Entry (PaTLE) and Pledge Allocation Payment Ledger Entry (PAPLE), to match the existing implied revenue. The matched implied revenue then can be removed from the total implied revenue when calculating the unrealized revenue in the system. The process will adjust the implied revenue based on one of three cases. However, the embodiments can also operate with accounting and donation management systems without implied revenue recognition where revenue information is available.

In a first case, when a payment is received that generates a positive payment, the revenue matching and reconciliation process (Split into Installments, Split into Allocations, Match to recognized revenue, and Reconcile (SISAMAR)) will run to create a PaTLE record as a copy of the payment and PAPLE record(s) based on the allocation information of the received payment and the matched revenue. After that, the PAPLE records will be linked to the installment record. Since the installment record has the PALE (revenue) record linked to it, the process can then match the PAPLE and PALE within the installment record. As a result, the remaining unrealized revenue on the installment record will be a sum of the PALE amounts minus a sum of the PAPLE amounts for each fund. In some cases, even one allocation will generate multiple PAPLEs if that allocation matches more than one chunk of revenue. The system will create one PAPLE for each pair of payment allocation and revenue satisfied combination. In other words, one allocation satisfying 2 chucks of revenue will create 2 PAPLEs. Similarly, 2 allocations satisfying 3 revenue chunks will create 6 PAPLEs because there are 6 combinations of allocations with revenue. The number of allocs*number of revenue chunks being satisfied=number of PAPLEs.

In a second case, where a payment is received that creates a negative payment (i.e., refund), the revenue matching and reconciliation process will run to create a negative PaTLE record as a copy of the negative payment and negative PAPLE record(s) based on the allocation information of the payment and the matched revenue being refunded. After that, those negative PAPLE records will be linked to the installment record that has the positive PAPLEs linked to it. Similar to the positive payment case, the process then can calculate the remaining implied revenue on the installment record by doing a sum of the PALE Amount minus a sum of the (positive PAPLE Amount) plus the sum of the negative PAPLE Amount for each fund.

In a third case, when the received payments (both positive and negative) get updated, the revenue matching and reconciliation process will reverse the PaTLE and PAPLE records that were created previously. After that, the process will recreate the PaTLE and PAPLE records based on the updated payment information.

The embodiments describe the operation of a donation management system. The donation management system tracks opportunities, also referred to as donations as record that represents a donation in the donation management system. The record stores the total amount promised for the opportunity among other things. In embodiments where implied revenue recognition is provided, this amount will be used to cap the total scheduled implied revenue that the system can recognize.

Similarly, where the embodiments operate in conjunction with an implied revenue process, the donation management system maintains a payment schedule, which is a collection of payments scheduled or received for a donation. In the donation management system, the payment schedule represents either what the donor has promised or has paid. This is a combined view of revenue and actual payments. The donation management system tracks revenue and actual payments separately. Thus, the donation management system will monitor the payment schedule and detect if there are any changes to it and then determine if the changes should affect recognized revenue. SISAMAR does not monitor scheduled payments, it only looks at received payments. Also, SISAMAR will work on systems that explicitly track revenue as well as on systems that use Implied Revenue Recognition. The method used to capture revenue will have no effect on SISAMAR behavior.

In the donation management system ‘payment records’ are records used to store an amount, and a date that a payment was paid (or, in some systems, expected to be paid), among other data. The payment records can be scheduled payments (unpaid) or actual payments (paid). A General Accounting Unit (GAU) represents a fund (in fund accounting which is required for non-profits). The donation management system supports fund accounting and accrual accounting.

‘Payment allocations’ are records that represent how much of each payment will be allocated to each GAU or fund. Payment allocations are to payments as PALEs are to installments. Installments are records that represent revenue for a date without taking into consideration how it will be allocated. The installment tracks total revenue amount and date. Revenue allocation is represented by PALEs. Ledger entries represent information to be sent to an accounting system from the donation management system. There are three types of ledger entries (PALE, PaTLE, and PAPLE).

A PALE (Pledge Allocation Ledger Entry) represents how much of each installment will be allocated to each GAU or fund. The PALE represents revenue and tracks all three components of revenue (amount, date, and allocation). A PaTLE (Payment Transaction Ledger Entry) is a copy of the information contained in the payment record which will be sent to accounting instead of payment records. A PAPLE (Pledge Allocation Payment Ledger Entry) represents actual money that will be matched to revenue (PALE). The revenue matching and reconciliation process, also referred to a SISAMAR (Split into Installments, Split into Allocations, Match to recognized revenue, and Reconcile) is a process used to match payments to revenue.

In the following description, numerous specific details such as implementations, types and interrelationships of system components, and logic partitioning/integration choices are set forth in order to provide a more thorough understanding. It will be appreciated, however, by one skilled in the art, that the invention may be practiced without such specific details. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

In the following description and claims, the term “coupled,” along with its derivatives, may be used. “Coupled” is used to indicate that two or more elements, which may or may not be in direct physical or electrical contact with each other, co-operate or interact with each other.

The operations in the flow diagrams are described with reference to the exemplary implementations in the other figures. However, the operations of the flow diagrams can be performed by implementations other than those discussed with reference to the other figures, and the implementations discussed with reference to these other figures can perform operations different than those discussed with reference to the flow diagrams.

While the flow diagrams in the figures show a particular order of operations performed by certain implementations, it should be understood that such order is exemplary (e.g., alternative implementations may perform the operations in a different order, combine certain operations, overlap certain operations, etc.).

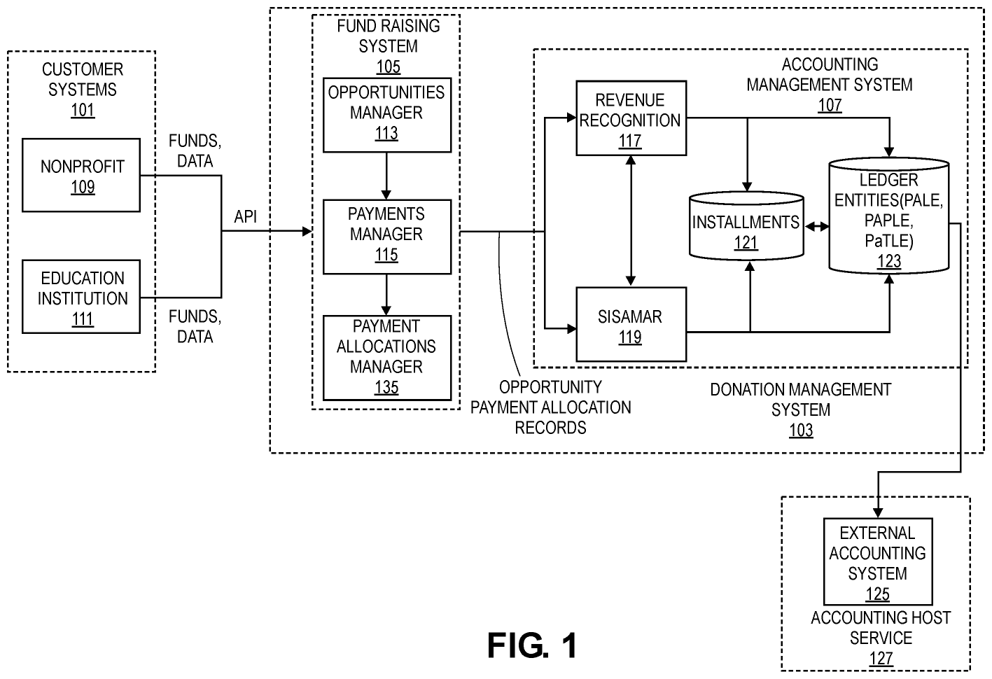

FIG. 1 is a block diagram of a donation management system that includes an accounting management system that implements a revenue matching and reconciliation process. The donation management system 103 can include additional elements and subsystems that are not illustrated or further discussed herein. The most relevant components of the donation management system 103 and related systems are shown for sake of clarity and conciseness. One skilled in the art would appreciate that these systems and components would include additional components and systems.

An accounting management system 107 is illustrated as part of a donation management system 103 and interfacing with a fundraising system 105 as well as an external accounting system 125 by way of example and not limitation. The functions of the accounting management system 107 could be separately implemented or integrated into other components in other configurations and arrangements. The donation management system 103 interfaces with a set of customer systems 101 such as nonprofits 109 and educational system 111. Any number of customer systems 101 can interface with separate instances of the fundraising system 105 via an API of the donation management system 103. The donation management system 103 can be hosted by a multi-tenant cloud-based service.

The customer systems 101 provide an interface or ‘front-end’ to access and enter data into the donation management system 103. A user of a customer system 101 can set up and enter fund and payment information into the fundraising system 105. The customer systems 101 can be specialized local client applications or general purpose applications such as web browsers. In some embodiments, the customer systems 101 interact with the fundraising system via existing APIs that are not modified to accommodate accrual accounting.

The fundraising system 105 can include multiple functions including opportunities (e.g., donations, gifts) manager 113, payments manager 115, and payment allocation manager 135. In the fundraising system 105, an opportunity, also referred to as donation or pledge, is managed by the opportunities manager 113. The opportunities manager 113 maintains an opportunity record that represents a specific donation in the fundraising system 105. The opportunity record stores the total amount promised. Additional information about the opportunity such donor information and related data can also be stored in the opportunity record.

The payments manager 115 maintains a payment schedule. The payment schedule is a data structure that is a collection of payment records for payments received for a specific opportunity or donation. In the fundraising system 105 payment schedule represents what the donor has either promised or has paid. This is a combined view of revenue and actual payments. As discussed further herein below, the revenue recognizer 117 monitors the payment schedule and detects any changes to it to determine if they should affect recognized revenue. The payment records are data structures used to store amount, and date a payment was paid or expected to be paid, among other data. They can be scheduled payments (unpaid) or actual payments (paid).

A payment allocation manager 135 manages payment allocation records. Payment allocation records are records that represent how much of each payment will be allocated to each general accounting unit (GAU) or fund. The GAU represents a fund (e.g., in fund accounting which is required for nonprofits). The embodiments support both fund accounting and accrual accounting. A fund is an accounting representation of a project or cause that the donation is allotted to support. Each GAU allocation can be a record with the allotment details for donations and payments.

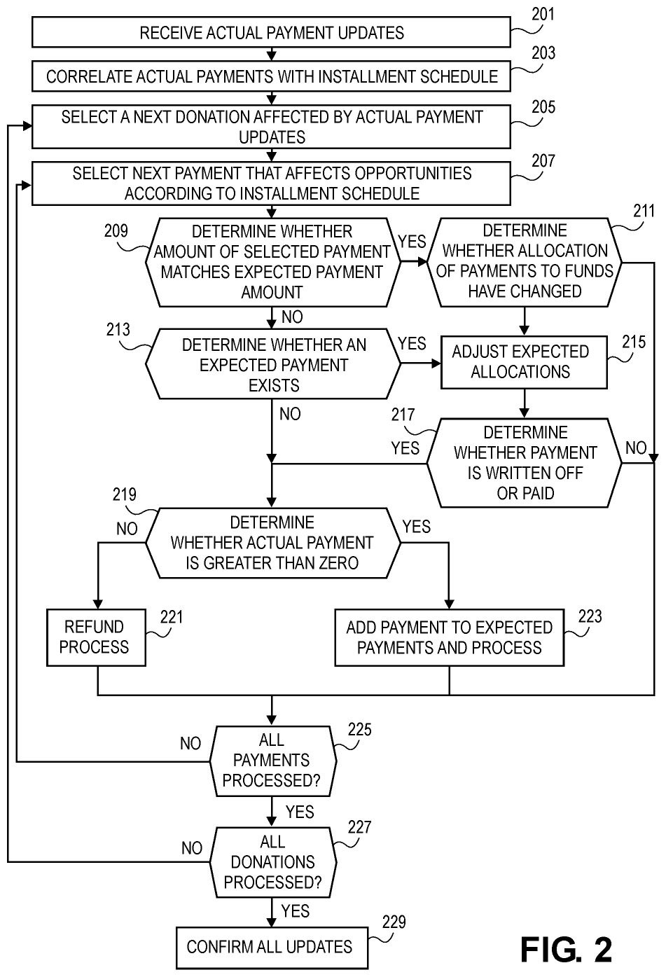

The fundraising system 105 makes accessible or passes the opportunity records, payment records, and allocation records to the accounting management system 107. The functions of the accounting management system 107 include a revenue recognizer 117 and a split into installments, split into allocations, match to recognize revenue, and reconcile (SISAMAR) 119 also referred to as a revenue matching and reconciliation process. The SISAMAR 119 functions to split payments into installments, and split the payments into allocations, match allocations to recognized revenue, and to reconcile. Thus, the SISAMAR implements a method to match payments to revenue. The operation of the SISAMAR or revenue matching and reconciliation process is described further herein below with reference to FIGS. 2-5.

In some embodiments where implied revenue is determined, a revenue recognizer 117 works in combination with the SISAMAR 119. However, SISAMAR can operate in systems without implied revenue recognition and the revenue recognizer 117. The revenue recognizer 117 processes opportunity records, payment records, and payment allocation records to identify revenue that is not explicitly provided to the donation management system 103. The revenue recognizer 117 accounts for changes in the payment date, allocation, and amount (increase or decrease) when paid or promised payments are modified in the payment schedule without making changes to the user interface or to the API's. The revenue recognizer will synchronize the revenue schedule with the changes made in the payment schedule by implying what effect those changes should have on revenue. The revenue recognizer enables end users and other customer systems to interact only with the payment schedule (i.e., not having to input corresponding revenue information). The revenue recognizer will then automatically keep track of revenue by figuring out or implying it from those payment schedule interactions.

The revenue recognizer 117 does not need to make adjustments when what is promised matches exactly what is delivered by a donor. In that case the revenue recognizer duplicates the expected payment schedule into the revenue schedule. However, when a donor changes her mind after the initial commitment, the payment schedule is updated and the revenue recognizer will imply, by analyzing those changes, how and if any of those changes need to be reflected in the revenue schedule.

In general, any changes to one of the three components of revenue (amount, date, or allocation) can result in changes to the revenue schedule. When one or more of those components are modified in the payment schedule the revenue recognizer determines if any of those changes need to be reflected on the revenue schedule and how those changes will be implemented.

Regardless of recognition of implied revenue, examples of what can be determined by SISAMAR from changes in the payment schedule include overpayments at a pledge level, and overpayments at an installment level. An overpayment at the pledge level occurs if a donor decides to overpay the last payment in the schedule, such that the overpayment will result in an increase in the overall donation (also referred to as a pledge or opportunity). For example, a donor promises $200 in 2 payments of $100. The first payment comes in as promised, but when the second payment arrives, it is for $150. In this case the SISAMAR can determine that there is $50 in new revenue that needs to be added to the revenue schedule.

Similarly, SISAMAR can address an overpayment at the installment level that occurs in the case that a donor overpays a payment other than the final payment. As discussed further herein below, an installment is a record that represents revenue for a given date without taking into consideration how it will be allocated. In the case of an overpayment, SISAMAR analyzes the impact of this change before it can determine if the change will impact the revenue schedule. For example, if a donor promised two payments of $100 each and overpays the first one by $110 (i.e., the initial payment is $210), this will result in $10 of new revenue. But if the donor overpays the same (i.e., first) payment by $10 (e.g., the initial payment is $110), SISAMAR cannot yet determine if this change will ultimately result in a donation overpayment or if the donor was just paying ahead. In this case, SISAMAR will hold off modifying revenue until sufficient money comes in to make that determination.

A re-allocation of funds for a future installment occurs where a donor pledges two payments of $100 and originally allocates her donation equally split into two funds (e.g., a. music department and computer science department at a recipient university), the donor makes the first payment with that allocation, and then decides to update her allocation for the second payment so that 100% goes to the music department. In this case SISAMAR needs to update the revenue schedule to reduce $50 of revenue from what was promised to the computer science fund and increase by $50 the revenue promised towards the music department fund.

The SISAMAR 119 interacts with a data store for management of installment records in an installments database 121 and ledger entries in a ledger database 123. Installments records are data structures that represent revenue for a date without taking into consideration how it will be allocated. Each installment record tracks total revenue amount and date. Revenue allocation is represented by a pledge allocation ledger entry (PALE). A ledger entry is an entry in a data structure that represents information to be sent to an accounting system from the accounting management system 107. There are three types of ledger entries, a PALE, a payment transaction ledger entry (PaTLE), and a pledge allocation payment ledger entry (PAPLE). The PALE is a data structure that represents how much of each installment will be allocated to each GAU or fund. The PALE represents revenue and tracks all three main components of revenue (i.e., amount, date, and allocation). The PaTLE is a copy of the information contained in the payment record of the fundraising system 105, which can be sent to accounting instead of the payment records. PaTLEs are created so that transactional information can be sent to external accounting systems without having to rely on payment records since payment records might need to be updated after they are posted. The PAPLE is a data structure that represents actual money that will be matched to revenue (i.e., a PALE).

The accounting management system 107 can interface with or provide access to installments and/or ledger entries for accounting system 125. The accounting systems 125 can utilize this information to perform accounting activities without having to rely on manual guesswork to correlate payment information, donation information, and revenue information. The accounting system 125 can be a part of the donation management system 103 or can be a separate system (e.g., an external accounting system 125 provided by an accounting host service 127).

FIG. 2 is a flowchart of one embodiment of the revenue matching and reconciliation process. The process is triggered when a payment is received. The donations are scheduled into installments where each installment is proportionately allocated to a fund or GAU. When a payment is received that changes expected revenues the payment is correlated with a particular installment, i.e., a next unpaid installment that is expected to be paid chronologically. If the amount of the received payment is greater than the next installment, then the amount is split to cover the next installment and further installments depending on the amount of the received payment. For each of the installments where the amount of the received payment is applied, the amount of the payment for the given installment is also correlated with allocations to specific funds or GAUs. In cases where a received payment specifies allocation to funds or GAUs, then the amount of the payment applied to the GAUs can be correlated with allocations across installments. If the changes in allocation or the total payments require changes in the already recorded revenue, then a reconciliation process reverses and recreates PALEs, then inserts the correct PAPLEs and PaTLEs. Thus, the process is referred to as SISAMAR where payments are split into installments (SI), split into allocations (SA), matched (M), and reconciled (AR).

One embodiment of the revenue matching and reconciliation or SISAMAR process is shown in FIG. 2, where responsive to a received payment the process determines what changes to the records related to revenue need to be updated. The process can be triggered by receiving data related to actual payments (Block 201). The received data can be related to a single payment or with multiple payments. Each of the received payment is associated with a set of donations and is correlated with the installment schedule for each donation (Block 203). The process then checks the installments for the donation and the allocations of these installments to match the amounts from the received actual payment with the recorded revenue on a per donation, per installment and per allocation basis.

In the example, the process iterates on the donations, installments and allocations. One skilled in the art would appreciate that this information can be traversed in different orders such that all of the affected records are identified and updated. In the example, a next donation affected by the received payments, is selected for processing (Block 205). Then a next received payment that affects the selected donation based on the installment schedule is selected (Block 207).

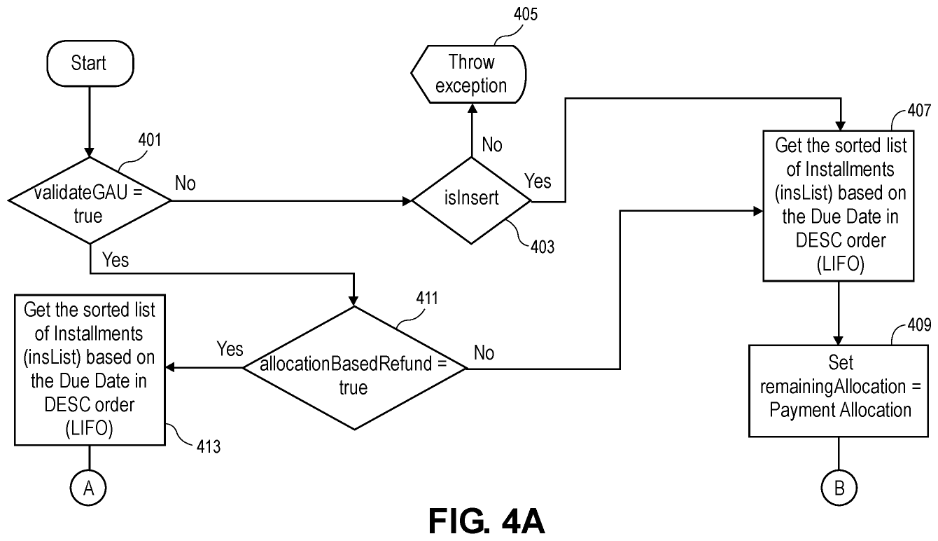

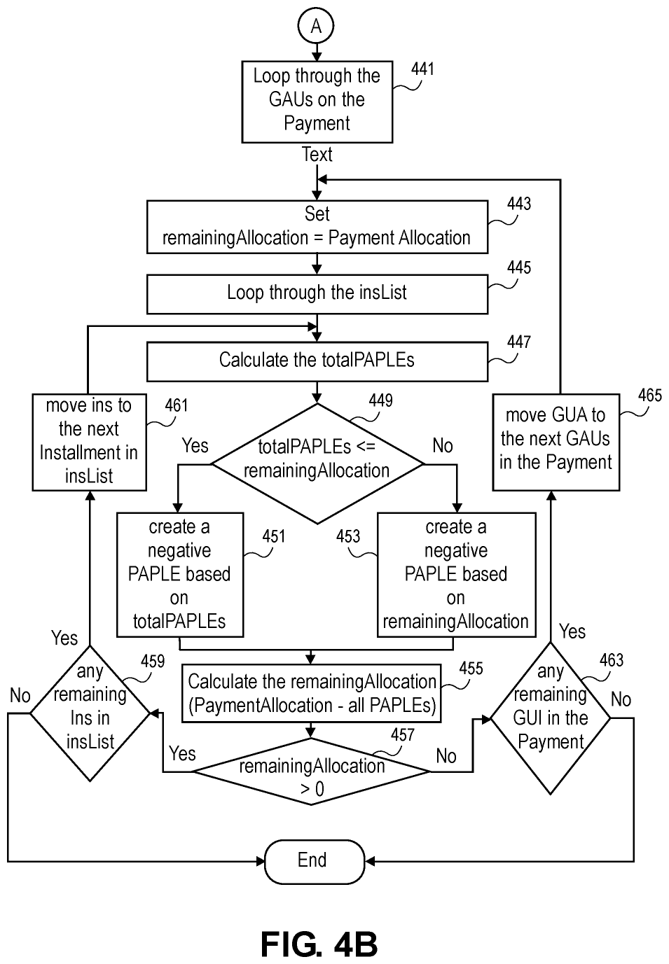

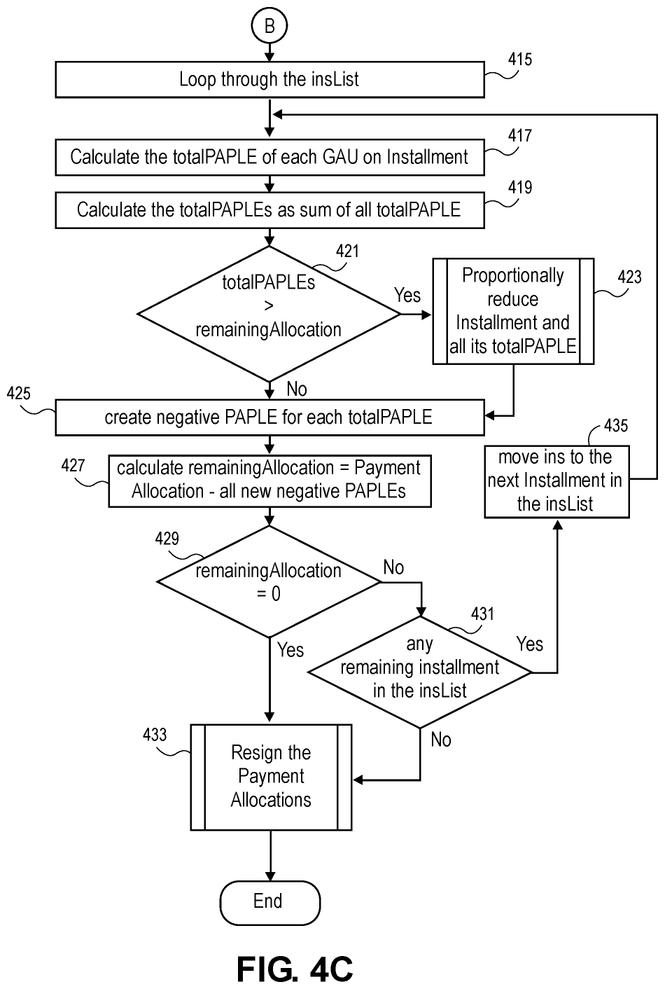

A check is made whether the amount of the selected received payment matches an expected recorded payment amount (Block 209). If the received payment amount does not match the expected payment amount (i.e., does not match the installment schedule), then the process determines whether expected payments exist in the donation management system for the payment as it applies to the selected donation (Block 213). If no expected payment exists, then the received payment amount is examined to determine whether it is greater than zero (Block 219). If the actual payment is greater than zero, ten payment records are added to the expected payment records (Block 223). If the actual payment is less than zero (e.g., an indication that a paid amount has been refunded or charged back), a refund process is initiated (Block 221). The refund process, described further in relation to FIGS. 4A-4C, reverses and refunds the amounts attributed to specific funds or GAUs. If further payments remain to be processed (Block 225), then a next payment is selected (Block 207). If no further payments for a given donation remain to be processed, then a next donation can be selected (Blocks 227 and 205). If all donations have been processed, then the changes to the donation management records can be confirmed.

If a selected received payment has an amount that matches the expected payment amount (Block 209), then a check is made whether the allocations of the selected received payment have changed (Block 211). If the allocations have not changed, then the process can move to the next received payment (Block 225) or donation (Block 227) before completing and confirming updates (Block 229). If the allocations have changed (Block 211) or the selected received payment amount does not match the expected payment amount (Block 209 and 213), then expected payment and allocation records are adjusted (Block 215). This can include adding, reversing, or altering records such as installment schedules, PaTLEs, PAPLEs, and similar data structures and records that track payments and revenue for the donation management system.

A check is made to determine whether an expected payment has been written off or paid in full (Block 217). If the payment has not been written off or paid, then the process checks whether further payment (Block 225) or donations (227) remain to be processed before confirming the updates to the records (Block 229). If the expected payment has been written off or paid, then the process determines whether actual payment is greater than zero (Block 219). If the actual payment is greater than zero, ten payment records are added to the expected payment records (Block 223). If the actual payment is less than zero (e.g., an indication that a promised amount has been canceled), a refund process is initiated (Block 221). The refund process, described further in relation to FIGS. 4A-4C, reverses and refunds the revenue attributed to specific funds or GAUs. If further payments remain to be processed (Block 225), then a next payment is selected (Block 207). If no further payments for a given donation remain to be processed, then a next donation can be selected (Blocks 227 and 205). If all donations have been processed, then the changes to the donation management records can be confirmed.

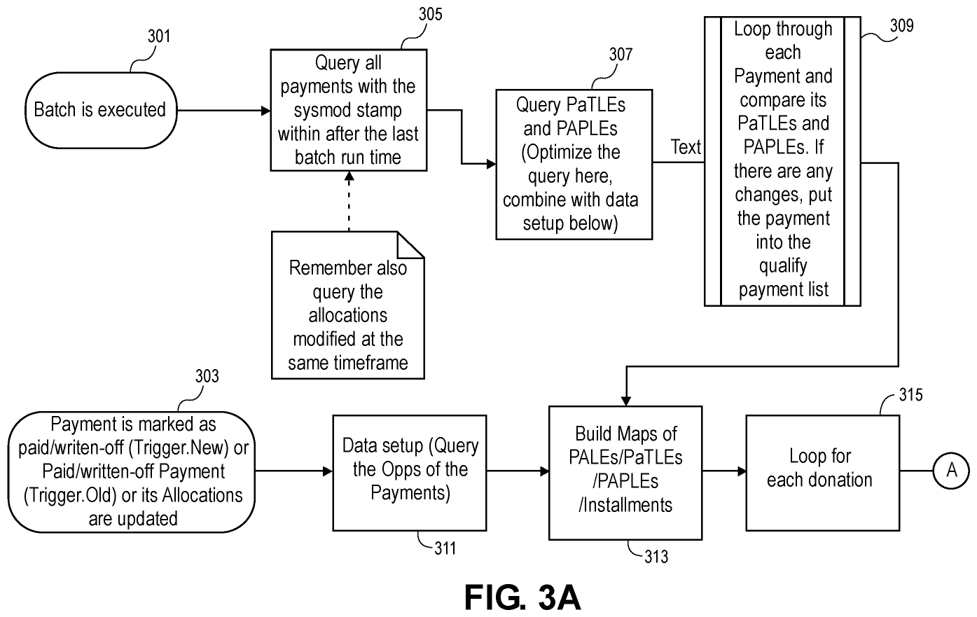

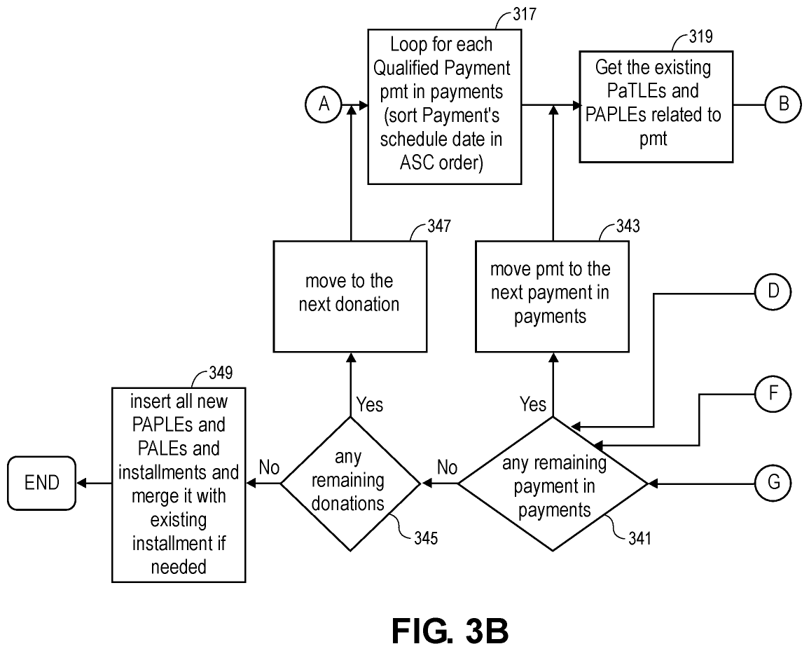

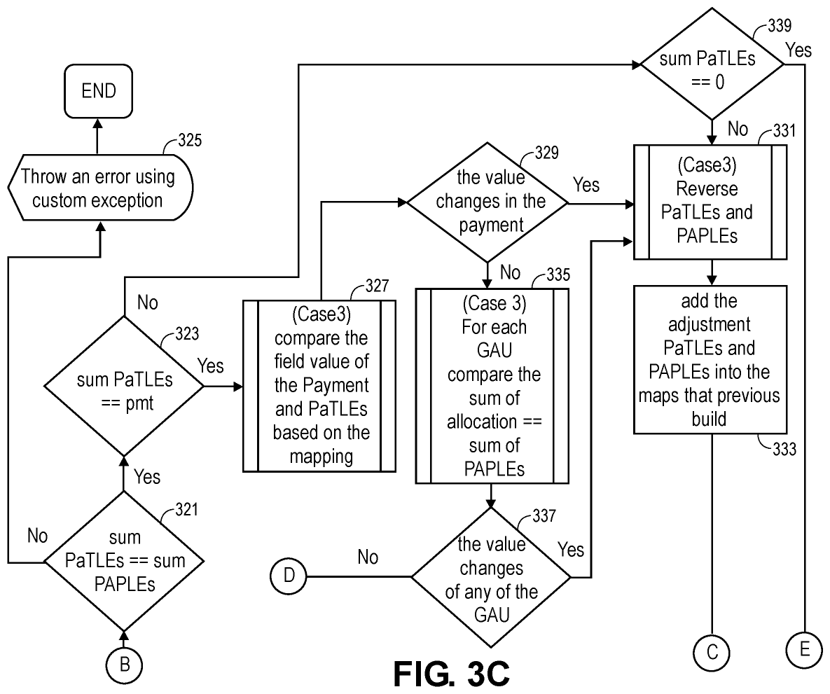

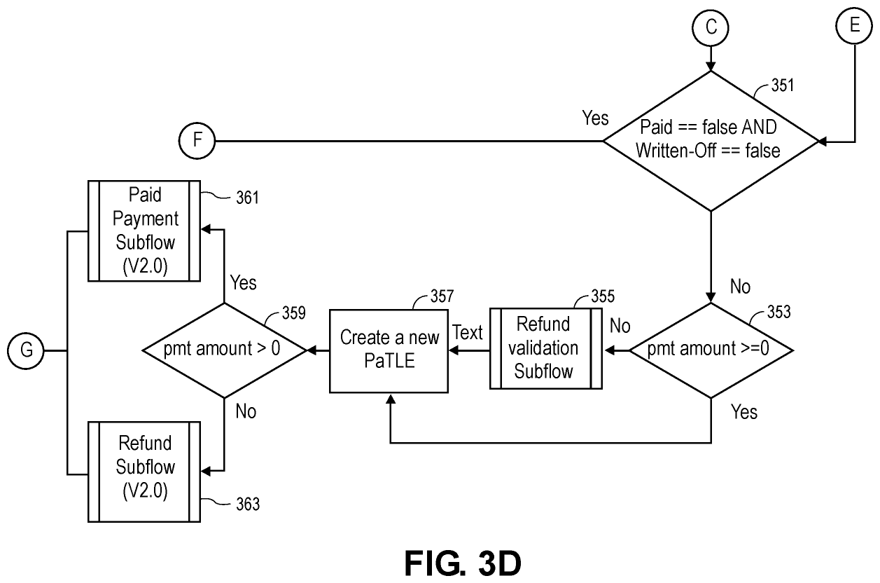

FIG. 3A is a flowchart of one example implementation of the revenue matching and reconciliation process. In the example, the revenue matching and reconciliation process can be triggered either by the receipt of a batch of updates (Block 301) or the receipt of updates to payments and/or allocations (Block 303) that can be received from the revenue recognition component or the fundraising system. Where a batch has been processed a query can be executed to find all payments that have been received since the last batch run (Block 305) as well as all allocation changes. The PaTLEs and PAPLEs are queried to find those associated with the batch of received payments (Block 307). The revenue matching and reconciliation process then begins to iterate through the each received payment from the batch to compare the associated PaTLEs and PAPLEs and to place the payments with modifications into a queue for further processing (Block 309).

Where the revenue matching and reconciliation process has been triggered by a payment and/or allocation update (Block 303), then the associated allocation and donation/opportunity data is retrieved for the updated payment/allocation including associated PaTLE and PAPLEs (Block 311). In both cases (batch receipt of payment/allocation update), the retrieved accounting information associated with the payments/allocations that have changed is correlated (Block 313). A map of correlated PALEs/PaTLEs/PAPLEs/Installments is constructed. With this information marshalled, the revenue matching and reconciliation process can begin to iterate through the information to identify the cases where records must be updated for reconciliation. (Block 315).

Continuing to the flowchart of FIG. 3B of the revenue matching and reconciliation process, for a given donation each associated payment is iteratively processed such that a next payment associated with the current donation is selected (Block 317). The payments can be sorted in any manner e.g., by ascending scheduled date of payment. Once a next payment has been selected for processing, then the existing PaTLEs and PAPLEs related to the payment are retrieved (Block 319). A check is made whether the sum of the existing PaTLEs related to the payment is equal to the sum of the existing PAPLEs associated with the payment (Block 321). If the two sums are not equal, then there is an error in the system that needs to be resolved prior to processing and error is thrown (Block 325).

If the existing data is accurate, then a check is made whether the sum of the PaTLEs is equal to the received payment (Block 323). If the sum of the PaTLEs is equal to the amount of the received payment, then the received payment has not deviated from the expected payment amount. If the received payment does not deviate from the expected payment, there still may be changes in allocation. A check is made to compare the field value of the received payment and the PaTLEs based on the previously built mappings (Block 327). A check is then made to determine whether any of the values changed in the received payment relative to the values of the PaTLEs (Block 329). If changes are found, then the PaTLEs and corresponding PAPLEs that vary from the actual payment are reversed (Block 331). PaTLEs and PAPLEs are then added into the mapping to adjust for the changes in the actual payments (Block 333).

In the case where no values were found to change between the PaTLEs and the received payments, each GAU allocation associated with the payment and PAPLEs is compared with the sum of the PAPLEs (Block 335) to determine whether there are changes in the allocations in the received payments (Block 337). If changes are found, then the PaTLEs and corresponding PAPLEs that vary from the actual payment allocations are reversed (Block 331). PaTLEs and PAPLEs are then added into the mapping to adjust for the changes in the actual payment allocations (Block 333).

In the case where the sum of the PaTLEs is equal to the sum of the PAPLEs (Block 321) and the sum of the PaTLEs is not equal to the payment amount (Block 323), a check is made to determine whether the sum of the PaTLEs is equal to zero, indicating that there are no corresponding PaTLEs to adjust (Block 339). If the sum of the PaTLEs is not zero, then the PaTLEs and corresponding PAPLEs that vary from the actual payment are reversed (Block 331). PaTLEs and PAPLEs are then added into the mapping to adjust for the changes in the actual payment (Block 333).

Where the currently selected received payment does not change the mapping of PaTLEs and PAPLEs after checks of the changes in the payment values (Block 329) and GAU allotments (Block 337), then the process (returning to FIG. 3B) completes processing of the selected payment and checks to determine whether the additional received payments to process (Block 341). If there are received payments remaining to be processed, then the next received payment is selected (Block 343) and the associated PaTLEs and PAPLEs are retrieved (Block 319) for further processing. If no received payments remain to be processed, then the process checks whether any donations remain to be processed (Block 345). If further donations remain to be processed, then the next donation is selected (Block 347) and the associated payments are organized (Block 317) for further processing.

If no further donations or payments remain to be processed, then the PAPLEs, PALEs, and installments generated during the revenue matching and reconciliation process are inserted into the donation management system and merged with any existing installments as needed (Block 349) thereby completing the process.

Turning to FIG. 3D of the revenue matching and reconciliation process, in cases where there were no PaTLEs (Block 339) associated with a payment or where PaTLEs and PAPLEs were reversed (Block 331) and added (Block 333), then a check is made whether the payment is designated paid or written off (Block 351).

If the payment is neither paid nor written off, then the process for revenue matching and reconciliation proceeds to process the next payment (Blocks 341 and 343) or donation (Blocks 345 and 347), if any before completing (Block 349) (See FIG. 3B). If the payment is either not paid or not written-off, then a check is made to determine if the received payment is greater than zero (Block 353). If the received payment is not greater than zero, indicating a negative payment, then a refund validation process (i.e., refund validation subflow) is executed (Block 355). The refund validation process confirms the validity of a refund related to the negative payment. If the refund is validated, then a new PaTLE is created for the refund (Block 357). If the payment amount is greater than zero (Block 353), then a new PaTLE is created for the payment (Block 357). Where the payment amount is greater than zero (Block 359) a paid payment process is triggered (Block 361) that updates and reconciles the installments, PAPLEs, and PaTLEs with the payment. Where the payment amount is less than zero (Block 359) a refund process is triggered (Block 363) that updates and reconciles the installments, PAPLEs, and PaTLEs with the payment. The refund process is described further herein below with relation to FIGS. 4A-4C. After the payment process (Block 361) or refund process (Block 363) complete, then the process for revenue matching and reconciliation proceeds to process the next payment (Blocks 341 and 343) or donation (Blocks 345 and 347), if any before completing (Block 349) (See FIG. 3B).

FIGS. 4A-4C are flowcharts of one example embodiment of a refund process that is part of the revenue matching and reconciliation process. In the example refund process, a check is made whether a GAU that is analyzed for the refund is valid (Block 401). If the GAU or fund is not valid, and the operation to be taken on the GAU is to insert (Block 403), then an error exception is thrown (Block 405). If the operation is not an insert, then the refund process can continue by retrieving a sorted list of installments where the sorting is a descending order of due dates for the installments (Block 407) for further processing where the remaining allocations are set to be equal to the payment allocation (Block 409).

Continuing to FIG. 4C the refund process iterates through the sorted installment list (Block 415) by selecting a next installment from the list. In each iteration, the total PAPLE of each GAU on a currently selected installment is calculated (Block 417). The total PAPLEs as a sum of all total PAPLEs is calculated (Block 419). The total PAPLEs is compared with a remaining allocation (Block 421). If the total PAPLEs is greater than the remaining allocations for an installment, then the installment and the associated total PAPLE is proportionately reduced (Block 423). IF the total PAPLE is not greater than the remaining allocations for an installment or after the proportional reduction, then a negative PAPLE for each total PAPLE is crated (Block 425). A calculation of the remaining allocation is made by subtracting all the new negative PAPLEs from the payment allocation (Block 427).

A check is then made whether the remain allocation for the payment is zero (Block 429). If the payment amount yet to be allocated is zero, then the process resigns or completes the payment allocations (Block 433) and completes. If the remaining amount to allocate is not zero, then a check is made whether there are remaining installments in the sorted list to process (Block 431). If there are no further installments, then the payment allocations are confirmed (Block 433) and the refund process completes. If there are further installments to process, then the next installment is selected (Block 435) and the next iteration of the loop through the installment list continues (Block 415).

Returning to FIG. 4A, if the GAU is valid, then a check is made whether the refund is an allocation based refund (Block 411). The refund process can continue by retrieving a sorted list of installments based on due date in descending order (Block 413). Continuing to FIG. 4B, the refund process iterates through the GAUs associated with the received payment being processed (Block 441). The iterative processing of each GAU includes setting a remaining allocation to the payment allocation (Block 443), then iterating through the installment list (Block 445).

In the iteration through the installment list, a total of PALEs is calculated (Block 447). A check of whether the total of the PALEs for the installment is less than or equal to the remaining allocation is made (Block 449). If the total of the PAPLEs is less than or equal to the remaining allocation, then a negative PAPLE is created based on the total PAPLEs (Block 451). If the total of the PAPLEs is greater than the remaining allocation, then a negative PAPLE based on the remaining allocation is created (Block 453). After the creation of the negative PAPLE the remaining allocation is calculated by subtracting all PAPLEs from the payment allocation (Block 455). A check of whether the remaining allocation is greater than zero is then made (Block 457).

If the remaining allocation is greater than zero, then a check is made whether there are any remaining installments in the process (Block 459). If there are no remaining installments in the list, then the refund process completes. If there are additional installments to process, then the next installment is selected (Block 461) and the next iteration starts (Block 447). If the remaining allocation is zero or less, then a check is made whether there are any remaining GAUs in the received payment (Block 463). If there are no remaining GAUs then the refund process completes. If there are additional GAUs to process, then a next GAU is selected (Block 465) and the next iteration on the GAUs is started (Block 443).

The term “user” is a generic term referring to an entity (e.g., an individual person) using a system and/or service. A multi-tenant architecture provides each tenant with a dedicated share of a software instance and the ability (typically) to input tenant specific data for user management, tenant-specific functionality, configuration, customizations, non-functional properties, associated applications, etc. Multi-tenancy contrasts with multi-instance architectures, where separate software instances operate on behalf of different tenants. A tenant includes a group of users who share a common access with specific privileges to a software instance providing a service. A tenant may be an organization (e.g., a company, department within a company, etc.). A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third party application developers providing applications/services and another set of tenants may be customers of different ones or all of the third-party application developers. A user may have one or more roles relative to a system and/or service. To provide some examples, a user may be a representative (sometimes referred to as an “end user”) of a tenant (e.g., a vendor or customer), a representative (e.g., an administrator) of the company providing the system and/or service, and/or a representative (e.g., a programmer) of a third-party application developer that is creating and maintaining an application(s) on a Platform as a Service (PAAS).

Electronic Device and Machine-Readable Media

One or more parts of the above implementations may include software and/or a combination of software and hardware. An electronic device (also referred to as a computing device, computer, etc.) includes hardware and software, such as a set of one or more processors coupled to one or more machine-readable storage media (e.g., magnetic disks, optical disks, read only memory (ROM), Flash memory, phase change memory, solid state drives (SSDs)) to store code (which is composed of software instructions and which is sometimes referred to as computer program code or a computer program) for execution on the set of processors and/or to store data. For instance, an electronic device may include non-volatile memory (with slower read/write times, e.g., magnetic disks, optical disks, read only memory (ROM), Flash memory, phase change memory, SSDs) and volatile memory (e.g., dynamic random access memory (DRAM), static random access memory (SRAM)), where the non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device is turned off, and that has sufficiently fast read/write times such that, rather than copying the part of the code/data to be executed into volatile memory, the code/data may be provided directly to the set of processors (e.g., loaded into a cache of the set of processors); in other words, this non-volatile memory operates as both long term storage and main memory, and thus the electronic device may have no or only a small amount of volatile memory for main memory. In addition to storing code and/or data on machine-readable storage media, typical electronic devices can transmit code and/or data over one or more machine-readable transmission media (also called a carrier) (e.g., electrical, optical, radio, acoustical or other form of propagated signals—such as carrier waves, infrared signals). For instance, typical electronic devices also include a set of one or more physical network interface(s) to establish network connections (to transmit and/or receive code and/or data using propagating signals) with other electronic devices. Thus, an electronic device may store and transmit (internally and/or with other electronic devices over a network) code and/or data with one or more machine-readable media (also referred to as computer-readable media).

Electronic devices are used for a variety of purposes. For example, an electronic device (sometimes referred to as a server electronic device) may execute code that cause it to operate as one or more servers used to provide a service to another electronic device(s) (sometimes referred to as a client electronic device, a client computing device, or a client device) that executes client software (sometimes referred to as client code or an end user client) to communicate with the service. The server and client electronic devices may be operated by users respectively in the roles of administrator (also known as an administrative user) and end user.

Example Environment

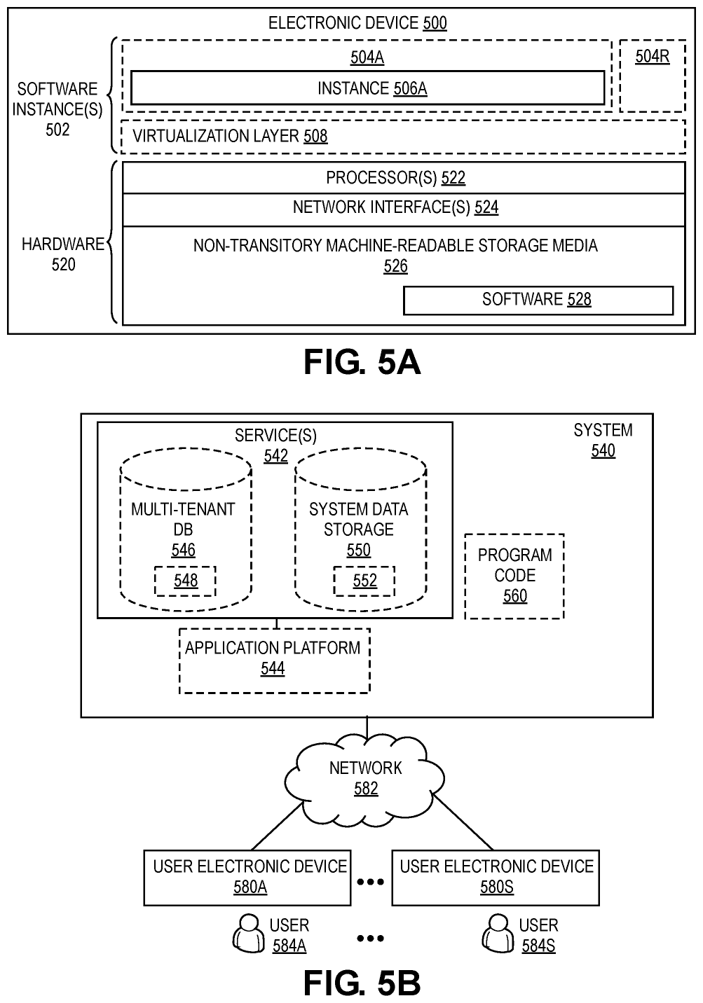

FIG. 5A is a block diagram illustrating an electronic device 500 according to some example implementations. FIG. 5A includes hardware 520 comprising a set of one or more processor(s) 522, a set of one or more network interfaces 524 (wireless and/or wired), and non-transitory machine-readable storage media 526 having stored therein software 528 (which includes instructions executable by the set of one or more processor(s) 522). Each of the previously described customer systems and the donation management system, as well as its functions such as the SISAMAR or revenue matching and reconciliation process may be implemented in one or more electronic devices 500. In one implementation: 1) each of the end user clients is implemented in a separate one of the electronic devices 500 (e.g., in user electronic devices operated by users where the software 528 represents the software to implement end user clients to interface with the Donation management system (e.g., a web browser, a native client, a portal, a command-line interface, and/or an application program interface (API) based upon protocols such as Simple Object Access Protocol (SOAP), Representational State Transfer (REST), etc.)); 2) the Donation management system is implemented in a separate set of one or more of the electronic devices 500 (e.g., a set of one or more server electronic devices where the software 528 represents the software to implement the Donation management system); and 3) in operation, the electronic devices implementing the end user clients and the Donation management system would be communicatively coupled (e.g., by a network) and would establish between them (or through one or more other layers) connections for submitting payment and pledge information to the donation management system. Other configurations of electronic devices may be used in other implementations (e.g., an implementation in which the end user client and the Donation management system are implemented on a single electronic device 500).

In electronic devices that use compute virtualization, the set of one or more processor(s) 522 typically execute software to instantiate a virtualization layer 508 and software container(s) 504A-R (e.g., with operating system-level virtualization, the virtualization layer 508 represents the kernel of an operating system (or a shim executing on a base operating system) that allows for the creation of multiple software containers 504A-R (representing separate user space instances and also called virtualization engines, virtual private servers, or jails) that may each be used to execute a set of one or more applications; with full virtualization, the virtualization layer 508 represents a hypervisor (sometimes referred to as a virtual machine monitor (VMM)) or a hypervisor executing on top of a host operating system, and the software containers 504A-R each represent a tightly isolated form of a software container called a virtual machine that is run by the hypervisor and may include a guest operating system; with para-virtualization, an operating system or application running with a virtual machine may be aware of the presence of virtualization for optimization purposes). Again, in electronic devices where compute virtualization is used, during operation an instance of the software 528 (illustrated as instance 506A) is executed within the software container 504A on the virtualization layer 508. In electronic devices where compute virtualization is not used, the instance 506A on top of a host operating system is executed on the “bare metal” electronic device 500. The instantiation of the instance 506A, as well as the virtualization layer 508 and software containers 504A-R if implemented, are collectively referred to as software instance(s) 502.

Alternative implementations of an electronic device may have numerous variations from that described above. For example, customized hardware and/or accelerators might also be used in an electronic device.

Exemplary Environment

FIG. 5B is a block diagram of an environment where a donation management system including SISAMAR may be deployed, according to some implementations. A system 540 includes hardware (a set of one or more electronic devices) and software to provide service(s) 542, including the donation management system. The system 540 is coupled to user electronic devices 580A-S over a network 582. The service(s) 542 may be on-demand services that are made available to one or more of the users 584A-S working for one or more other organizations (sometimes referred to as outside users) so that those organizations do not need to necessarily be concerned with building and/or maintaining a system, but instead makes use of the service(s) 542 when needed (e.g., on the demand of the users 584A-S). The service(s) 542 may communication with each other and/or with one or more of the user electronic devices 580A-S via one or more Application Programming Interface(s) (APIs) (e.g., a Representational State Transfer (REST) API). The user electronic devices 580A-S are operated by users 584A-S.

In one implementation, the system 540 is a multi-tenant cloud computing architecture supporting multiple services, such as a donation management system, a customer relationship management (CRM) service (e.g., Sales Cloud by salesforce.com, Inc.), a contracts/proposals/quotes service (e.g., Salesforce CPQ by salesforce.com, Inc.), a customer support service (e.g., Service Cloud and Field Service Lightning by salesforce.com, Inc.), a marketing service (e.g., Marketing Cloud, Salesforce DMP, and Pardot by salesforce.com, Inc.), a commerce service (e.g., Commerce Cloud Digital, Commerce Cloud Order Management, and Commerce Cloud Store by salesforce.com, Inc.), communication with external business data sources (e.g., Salesforce Connect by salesforce.com, Inc.), a productivity service (e.g., Quip by salesforce.com, Inc.), database as a service (e.g., Database.com™ by salesforce.com, Inc.), Data as a Service (DAAS) (e.g., Data.com by salesforce.com, Inc.), Platform as a Service (PAAS) (e.g., execution runtime and application (app) development tools; such as, Heroku™ Enterprise, Thunder, and Force.com® and Lightning by salesforce.com, Inc.), an analytics service (e.g., Einstein Analytics, Sales Analytics, and/or Service Analytics by salesforce.com, Inc.), a community service (e.g., Community Cloud and Chatter by salesforce.com, Inc.), an Internet of Things (IoT) service (e.g., Salesforce IoT and IoT Cloud by salesforce.com, Inc.), industry specific services (e.g., Financial Services Cloud and Health Cloud by salesforce.com, Inc.), and/or Infrastructure as a Service (IAAS) (e.g., virtual machines, servers, and/or storage). For example, system 540 may include an application platform 544 that enables PAAS for creating, managing, and executing one or more applications developed by the provider of the application platform 544, users accessing the system 540 via one or more of user electronic devices 580A-S, or third-party application developers accessing the system 540 via one or more of user electronic devices 580A-S.

In some implementations, one or more of the service(s) 542 may utilize one or more multi-tenant databases 546 for tenant data 548, as well as system data storage 550 for system data 552 accessible to system 540. In certain implementations, the system 540 includes a set of one or more servers that are running on server electronic devices and that are configured to handle requests for any authorized user associated with any tenant (there is no server affinity for a user and/or tenant to a specific server). The user electronic device 580A-S communicate with the server(s) of system 540 to request and update tenant-level data and system-level data hosted by system 540, and in response the system 540 (e.g., one or more servers in system 540) automatically may generate one or more Structured Query Language (SQL) statements (e.g., one or more SQL queries) that are designed to access the desired information from the one or more multi-tenant database 546 and/or system data storage 550.

In some implementations, the service(s) 542 are implemented using virtual applications dynamically created at run time responsive to queries from the user electronic devices 580A-S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 560 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 544 includes an application setup mechanism that supports application developers' creation and management of applications, which may be saved as metadata by save routines. Invocations to such applications, including the donation management system, may be coded using Procedural Language/Structured Object Query Language (PL/SOQL) that provides a programming language style interface. A detailed description of some PL/SOQL language implementations is discussed in U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007. Invocations to applications may be detected by one or more system processes, which manages retrieving application metadata for the tenant making the invocation and executing the metadata as an application in a software container (e.g., a virtual machine).

Network 582 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, or similar wired and/or wireless protocols, and may include one or more intermediary devices for routing data between the system 540 and the user electronic devices 580A-S.

Each user electronic device 580A-S (such as a desktop personal computer, workstation, laptop, Personal Digital Assistant (PDA), smart phone, etc.) typically includes one or more user interface devices, such as a keyboard, a mouse, a trackball, a touch pad, a touch screen, a pen or the like, for interacting with a graphical user interface (GUI) provided on a display (e.g., a monitor screen, a liquid crystal display (LCD), etc.) in conjunction with pages, forms, applications and other information provided by system 540. For example, the user interface device can be used to access data and applications hosted by system 540, and to perform searches on stored data, and otherwise allow a user 584 to interact with various GUI pages that may be presented to a user 584. User electronic devices 580A-S might communicate with system 540 using TCP/IP (Transfer Control Protocol and Internet Protocol) and, at a higher network level, use other networking protocols to communicate, such as Hypertext Transfer Protocol (HTTP), FTP, Andrew File System (AFS), Wireless Application Protocol (WAP), File Transfer Protocol (FTP), Network File System (NFS), an application program interface (API) based upon protocols such as Simple Object Access Protocol (SOAP), Representational State Transfer (REST), etc. In an example where HTTP is used, one or more user electronic devices 580A-S might include an HTTP client, commonly referred to as a “browser,” for sending and receiving HTTP messages to and from server(s) of system 540, thus allowing users 584 of the user electronic device 580A-S to access, process and view information, pages and applications available to it from system 540 over network 582.

### CONCLUSION

In the above description, numerous specific details such as resource partitioning/sharing/duplication implementations, types and interrelationships of system components, and logic partitioning/integration choices are set forth in order to provide a more thorough understanding. It will be appreciated, however, by one skilled in the art, that the invention may be practiced without such specific details. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

In the following description and claims, the term “coupled,” along with its derivatives, may be used. “Coupled” is used to indicate that two or more elements, which may or may not be in direct physical or electrical contact with each other, co-operate or interact with each other.

The operations in the flow diagrams are described with reference to the exemplary implementations in the other figures. However, the operations of the flow diagrams can be performed by implementations other than those discussed with reference to the other figures, and the implementations discussed with reference to these other figures can perform operations different than those discussed with reference to the flow diagrams.

While the flow diagrams in the figures show a particular order of operations performed by certain implementations, it should be understood that such order is exemplary (e.g., alternative implementations may perform the operations in a different order, combine certain operations, overlap certain operations, etc.).

While the above description includes several exemplary implementations, those skilled in the art will recognize that the invention is not limited to the implementations described and can be practiced with modification and alteration within the spirit and scope of the appended claims. The description is thus illustrative instead of limiting.

What is claimed is:

1. A computer implemented method of deterministic reconciliation and matching of payments with accounts receivable revenue for a donation management system, the method comprising:
receiving actual payment information from a fundraising system;
determining a set of donations, installments, and fund allocations affected by the actual payment information;
matching the actual payment information against the set of donations, installments, and fund allocations; and
adjusting recorded revenue amounts for at least one fund allocation record and payment record, in response to mismatching of the actual payment information against the set of donations, installments, and fund allocations in at least one database of an accounting management system.

2. The method of claim 1, further comprising:
determining whether the actual payment information indicates an allocation change to funds of a donation.

3. The method of claim 1, further comprising:
adjusting revenue allocated to each fund associated with a donation in response to a difference in payment amount.

4. The method of claim 1, wherein the actual payment includes a negative amount, further comprising:
creating a Payment Transaction Ledger Entry (PaTLE) and at least one Pledge Allocation Payment Ledger Entry (PAPLE) to indicate a negation of previously received payments.

5. The method of claim 1, further comprising:
constructing a mapping of expected payments, received? payments, fund allocations and installments.

6. The method of claim 1, further comprising:
generating a set of positive and negative Payment Transaction Ledger Entries (PaTLEs) and Pledge Allocation Payment Ledger Entries (PAPLEs) that describe actual payments, allocations, and portions of revenue satisfied by the actual payments.

7. The method of claim 1, further comprising:
reversing recorded revenue records in response to changes in expected revenue based on the actual payment information.

8. A non-transitory machine-readable storage medium that provides instructions that, if executed by a processor, will cause said processor to perform operations to implement a method of deterministic reconciliation and matching of payments with accounts receivable revenue for a donation management system, the operations comprising:
receiving actual payment information from a fundraising system;
determining a set of donations, installments, and fund allocations affected by the actual payment information;
matching the actual payment information against the set of donations, installments, and fund allocations; and
adjusting recorded revenue amounts for at least one fund allocation record and payment record, in response to mismatching of the actual payment information against the set of donations, installments, and fund allocations in at least one database of an accounting management system.

9. The non-transitory machine-readable storage medium of claim 8, the operations further comprise:
determining whether the actual payment information indicates an allocation change to funds of a donation.

10. The non-transitory machine-readable storage medium of claim 8, the operations further comprise:
adjusting revenue allocated to each fund associated with a donation in response to a difference in payment amount.

11. The non-transitory machine-readable medium of claim 8, wherein the actual payment includes a negative amount, further comprising:
creating a Payment Transaction Ledger Entry (PaTLE) and at least one Pledge Allocation Payment Ledger Entry (PAPLE) to indicate a negation of previously received payments.

12. The non-transitory machine-readable storage medium of claim 8, the operations further comprise:
constructing a mapping of expected payments, received? payments, fund allocations and installments.

13. The non-transitory machine-readable storage medium of claim 8, the operations further comprise:
generating a set of positive and negative Payment Transaction Ledger Entries (PaTLEs) and Pledge Allocation Payment Ledger Entries (PAPLEs) that describe actual payments, allocations, and portions of revenue satisfied by the actual payments.

14. The non-transitory machine-readable storage medium of claim 8, the operations further comprise:
reversing recorded revenue records in response to changes in expected revenue based on the actual payment information.

15. A computing device in a donation management system, the computing device comprising:
a non-transitory machine-readable storage medium having stored therein a process to Split into Installments, Split into Allocations, Match to recognized revenue, and Reconcile (SISAMAR);
a processor coupled to the non-transitory machine-readable storage medium, the processor to execute the SISAMAR, the SISAMAR to receive actual payment information from a fundraising system, determine a set of donations, installments, and fund allocations affected by the actual payment information, match the actual payment information against the set of donations, installments, and fund allocations, and adjust recorded revenue amounts for at least one fund allocation record and payment record, in response to mismatching of the actual payment information against the set of donations, installments, and fund allocations in at least one database of an accounting management system.

16. The computing device of claim 15, wherein the SISAMAR is further to determine whether the actual payment information indicates an allocation change to funds of a donation.

17. The computing device of claim 15, wherein the SISAMAR is further to adjust revenue allocated to each fund associated with a donation in response to a difference in payment amount.

18. The computing device of claim 15, wherein the actual payment includes a negative amount, the SISAMAR to further create a Payment Transaction Ledger Entry (PaTLE) and at least one Pledge Allocation Payment Ledger Entry (PAPLE) to indicate a negation of previously received payments.

19. The computing device of claim 15, wherein the SISAMAR is further to construct a mapping of expected payments, received? payments, fund allocations and installments.

20. The computing device of claim 15, wherein the SISAMAR is further to generate a set of positive and negative Payment Transaction Ledger Entries (PaTLEs) and Pledge Allocation Payment Ledger Entries (PAPLEs) that describe actual payments, allocations, and portions of revenue satisfied by the actual payments.

21. The computing device of claim 15, wherein the SISAMAR is further to reverse recorded revenue records in response to changes in expected revenue based on the actual payment information.
